(19) United States
(12) Patent Application Publication
(10) Pub. No.: US 2008/0274357 A1
(43) Pub. Date: Nov. 6, 2008

(54) RESIN COMPOSITION FOR MOLDING MATERIAL AND MOLDED ARTICLE MADE THEREFROM

(75) Inventors: Toshihiro Kasai, Otake-shi (JP); Mari Sekita, Kawasaki-shi (JP); Masakazu Ito, Otake-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Mitsubishi Rayon Co., Ltd., Tokyo (JP)

(21) Appl. No.: 12/039,897

(22) Filed: Feb. 29, 2008

Related U.S. Application Data
(63) Continuation of application No. 10/566,468, filed on Oct. 10, 2006, now abandoned.

(30) Foreign Application Priority Data
Jul. 31, 2003 (JP) 2003-283985
Oct. 24, 2003 (JP) 2003-365115

(51) Int. Cl. B32B 5/16; B29C 47/00; B29C 45/00

(52) U.S. Cl. 428/407; 264/176.1; 264/328.1

(57) ABSTRACT

A resin composition for molding materials according to the present invention comprising an acrylic polymer and a plasticizer, wherein the acrylic polymer consists of primary particles which have a core-shell structure comprising a core polymer and a shell polymer, and wherein the core polymer and shell polymer comprise methyl methacrylate monomer units and the core polymer has a lower content of methyl methacrylate monomer units than the shell polymer. The resin composition has high moldability during molding and gives a molded article having high hardness and high tear strength and reduced in plasticizer bleeding.

### CROSS REFERENCE TO RELATED APPLICATIONS

This application is a continuation of U.S. patent application Ser. No. 10/566,468, which is the U.S. National Stage of International Application No. PCT/JP04/10919, filed Jul. 30, 2004, the disclosures of which are incorporated herein by reference in their entireties. This application claims priority to Japanese Patent Application No. 2003-283985, filed Jul. 31, 2003, and Japanese Patent Application No. 2003-365115, filed Oct. 24, 2003, the disclosures of which are incorporated herein by reference in their entireties.

### TECHNICAL FIELD

The present invention relates to a resin composition for a molding material, comprising an acrylic polymer and a plasticizer.

### BACKGROUND ART

Acrylic resins possess excellent transparency and weatherability, and are used as a molding material in calendering, extrusion, injection molding and the like.

For example, acrylic resin films produced by a T-die extrusion process are used for surface protection of molded articles of polycarbonate, polyvinyl chloride and the like. Compared with the flexible polyvinyl chloride resin films that have been used in the past, flexible acrylic resin films are known to have excellent weatherability (e.g. Patent Document 1).

Patent Document 1: Japanese Patent Laid-Open No. 2000-103930

### DISCLOSURE OF THE INVENTION

### Problems to be Solved by the Invention

The present invention resolves the problem of poor moldability during molding, as well as the problems of a decrease in the hardness and tear strength of the obtained molded article, and occurrence of plasticizer bleeding, when an acrylic polymer and a plasticizer are used as a resin composition for mold processing.

### Means for Solving the Problem

The present invention is directed to a resin composition for a molding material comprising an acrylic polymer and a plasticizer, wherein the acrylic polymer consists of primary particles which have a core-shell structure comprising a core polymer and a shell polymer, and wherein the core polymer and shell polymer comprise methyl methacrylate monomer units and the core polymer has a lower content of methyl methacrylate monomer units than the shell polymer.

### EFFECT OF THE INVENTION

The resin composition for a molding material according to the present invention not only has excellent processability when molding is being conducted, but also the resulting molded article has excellent hardness and tear strength, and further, a molded article with no plasticizer bleeding can be obtained.

### BEST MODE FOR CARRYING OUT THE INVENTION

In the present invention the term “(meth)acrylic acid” means acrylic acid and/or methacrylic acid, and the term “(meth)acrylate” means acrylate and/or methacrylate. Further, in the present invention, the term “primary particles” means particles of the minimum unit constituting the polymer.

The acrylic polymer of the present invention consists of primary particles having a core-shell structure. A “core-shell structure” is a structure obtained by carrying out seed polymerization of monomer mixtures with different compositions through several stages. The term “seed polymerization” means a polymerization method of absorbing a monomer to a previously prepared polymer particle as a seed and polymerizing the absorbed monomer to grow the particle.

The acrylic polymer used in the resin composition for a molding material according to the present invention consists of primary particles which have a core-shell structure comprising a core polymer and a shell polymer.

The thickness of the shell portion is not particularly limited, but is preferably not less than about 10% of the size of the primary particles.

Acrylic polymers have methyl methacrylate monomer units both in a core polymer and in a shell polymer, wherein the content of methyl methacrylate mono-mer units in the core polymer has a lower content of methyl methacrylate monomer units than the shell polymer.

The content of methyl methacrylate monomer units in the core polymer is preferably between 0.01 and 90 mol %, and more preferably between 10 and 80 mol %. If the content of methyl methacrylate monomer units is less than 0.01 mol %, the core polymer is too compatible with the plasticizer, whereby its viscosity tends to increase. On the other hand, if the content of methyl methacrylate monomer units is more than 90 mol %, the core polymer is less compatible with the plasticizer. This causes a lower plasticizer retention and the plasticizer thus tends to bleed more, though the retention is an original objective for the core polymer.

Other copolymerizable monomers may also be used in the core polymer.

The content of methyl methacrylate monomer units in the shell polymer is preferably between 50 and 100 mol %, and more preferably between 60 and 100 mol %. If the content of methyl methacrylate monomer units is less than 50 mol %, the acrylic polymer becomes less coagulable when it is recovered.

The acrylic polymer used in the present invention preferably employs as its core polymer a polymer obtained from the polymerization of a monomer mixture comprising 20 to 85 mol % of methyl methacrylate, 15 to 80 mol % of a (meth)acrylic ester of a C2 to C8 aliphatic alcohol and/or aromatic alcohol and from 0 to 30 mol % of other copolymerizable monomers (wherein the total of the respective monomers is 100 mol %).

The shell polymer according to the present invention is preferably formed from the polymerization of a monomer mixture comprising 20 to 79.5 mol % of methyl methacrylate, 5 to 40 mol % of a (meth)acrylic ester of C2 to C8 aliphatic alcohol and/or aromatic alcohol, 0.5 to 10 mol % of a carboxyl group- or sulfonic acid group-containing monomer and from 0 to 30 mol % of other copolymerizable monomers.

The (meth)acrylic esters of C2 to C8 aliphatic alcohol and/or aromatic alcohol used in the present invention are not particularly limited, and there may be used, for example, (meth)acrylic esters of straight chain aliphatic alcohols, such as ethyl(meth)acrylate, n-butyl(meth)acrylate, i-butyl(meth)acrylate, t-butyl(meth)-acrylate, hexyl(meth)acrylate, 2-ethylhexyl(meth)acrylate and octyl(meth)acrylate; (meth)acrylic esters of cyclic aliphatic alcohols, such as cyclohexyl(meth)acrylate; and (meth)acrylic esters of aromatic alcohols, such as phenyl(meth)acrylate and benzyl(meth)acrylate. Preferred are n-butyl(meth)acrylate, i-butyl(meth)acrylate and t-butyl(meth)acrylate. These monomers are easily available and will be useful in commercialization of the acrylic polymer.

The carboxyl group- or sulfonic acid group-containing monomers are not particularly limited, and examples thereof include carboxyl group-containing monomers such as methacrylic acid, acrylic acid, itaconic acid, crotonic acid, maleic acid, fumaric acid, methacrylic acid 2-succinoloyloxyethyl-2-methacryloyloxyethyl-succinic acid, methacrylic acid 2-maleinoloyloxyethyl-2-methacryloyloxyethylmaleic acid, methacrylic acid 2-phthaloyloxyethyl-2-methacryloyloxyethylphthalic acid and methacrylic acid 2-hexahydrophthaloyloxyethyl-2-methacryloyloxyethylhexahydro-phthalic acid, and sulfonic acid group-containing monomers such as allylsulfonic acid. Methacrylic acid and acrylic acid are preferred. These are inexpensive and industrially readily available and are superior in copolymerizability with other acrylic monomers, and, thus, are preferred also from the point of productivity.

Furthermore, these acid group-containing monomers can be in the form of salts with alkali metals and the like. Examples of the salts include potassium salts, sodium salts, calcium salts, zinc salts and aluminum salts. These can be in the form of salts at the time of polymerization in an aqueous medium or can be in the form of salts after polymerization.

Examples of the other copolymerizable monomers used for the core polymer and the shell polymer include (meth)acrylates of alcohols of C9 or more carbon atoms, such as lauryl(meth)acrylate and stearyl(meth)acrylate; carbonyl group-containing (meth)acrylates such as acetoacetoxyethyl(meth)acrylate; hydroxyl group-containing (meth)acrylates such as 2-hydroxyethyl(meth)acrylate and 2-hydroxypropyl(meth)acrylate; epoxy group-containing (meth)acrylates such as glycidyl (meth)acrylate; amino group-containing (meth)acrylates such as N-dimethyl-aminoethyl (meth)acrylate and N-diethylaminoethyl(meth)acrylate; polyfunctional (meth)acrylates such as (poly)ethylene glycol di(meth)acrylate, propylene glycol di(meth)acrylate, 1,6-hexanediol di(meth)acrylate and trimethylolpropane tri(meth)-acrylate; acrylamide and derivatives thereof such as diacetonacrylamide, N-methylolacrylamide, N-methoxymethylacrylamide, N-ethoxymethylacrylamide and N-butoxymethylacrylamide; styrene and derivatives thereof; vinyl acetate; urethane-modified acrylates; epoxy-modified acrylates; and silicone-modified acrylates. These can be used in various applications and selected depending on the application.

The acrylic polymer used in the present invention preferably has a weight average molecular weight in the range of between 200,000 and 5,000,000. If the weight average molecular weight is less than 200,000, the physical properties, such as tear strength, of a molded article obtained by molding of the resin composition tend to deteriorate. On the other hand, if more than 5,000,000, the molding processability of the resin composition tends to deteriorate. From the perspective of moldability, the weight average molecular weight of the acrylic polymer is more preferably between 200,000 and 1,000,000, and most preferably, between 200,000 and 800,000. If the molecular weight is within this range, post-molding shrinkage is small, thereby providing good dimensional stability.

In addition, as the acrylic polymer of the present invention, it is preferable to use an acrylic polymer having a primary particle average particle size of 250 nm or more.

Examples of the plasticizer that may be used include dialkyl phthalate type such as dibutyl phthalate, dihexyl phthalate, dioctyl phthalate, diisononyl phthalate and diisodecyl phthalate; alkylbenzyl phthalate type such as butylbenzyl phthalate; alkylaryl phthalate type; dibenzyl phthalate type; diaryl phthalate type; triaryl phosphate type such as tricresyl phosphate; trialkyl phosphate type; alkylaryl phosphate type; adipic ester type; ether type; polyester type; and soybean oil type such as epoxidized soybean oil. Polypropylene glycol can also be used as the plasticizer. These plasticizers may be combined by appropriately selecting among them depending on the characteristics which each plasticizer possesses. Among them, phthalic ester type plasticizers are preferred because they are inexpensive and easily available commercially and also well processable and low toxic, for example.

These plasticizers can be used either alone or in a mixture of two or more depending on the purpose.

The compound amount of these plasticizers is not particularly limited, although a lower limit of 20 parts by weight per 100 parts by weight of the polymer is preferred. More preferable is 30 parts by weight or more. An upper limit is 100 parts by weight or less, and is more preferably 70 parts by weight or less. If the plasticizer is within this range, the molded article has a good balance of flexibility and strength.

The production method of the acrylic polymer used in the present invention is not particularly limited as long as the above-mentioned compositions and structures can be obtained. For example, a method comprising preparing core-shell type particles by seed polymerization and then recovering the particles as solid matter by spray drying or coagulation can be employed.

To obtain an acrylic polymer having a core-shell structure, especially an acrylic polymer having a primary particle size of not less than 250 nm, production can be performed using a method of growing particles by repeating seed polymerization many times, a method of obtaining the polymer by soap-free polymerization, a method of limiting the amount of emulsifier, a method of using an emulsifier with weak emulsifying ability or using a protective colloid, and the like. Among these methods, a preferable and industrially simple method is to employ seed polymerization which comprises preparing seed particles having a relatively large particle size by soap-free polymerization and sequentially adding dropwise thereto monomer mixtures.

A more preferable method comprises polymerizing, in a medium mainly composed of water, a monomer which has a solubility of not less than 0.02 wt. % in said medium at 20° C. and whose polymer is insoluble in said medium, using a water-soluble radical polymerization initiator in the absence of an emulsifier micelle in the medium, thereby obtaining a polymer dispersion, and adding dropwise a monomer mixture to the resulting polymer dispersion to obtain a coated polymer dispersion.

The reason for the above method being preferred is that soap-free polymerization per se hardly proceeds if a monomer which has a solubility of only less than 0.02 wt. % in the medium is used. Moreover, if the polymer obtained from the monomer dissolves into the medium, since no particles are formed, no polymer particles can be obtained. If an emulsifier micelle is present in the medium, this naturally does not meet the definition of soap-free polymerization and is unsuitable. The above method is advantageous because it is industrially simple, inhibits generation of scale and production of fresh particles, and can stably produce the desired particles.

As long as the acrylic polymer comprise primary particles having a core-shell structure as described above, it may have a secondary or higher order structure, for example, a secondary structure wherein the primary particles coagulate with a weak cohesion or strong cohesion, or they are fusion bonded to each other by heat.

Furthermore, these secondary particles can take a higher order structure by a treatment such as granulation. Such a higher order structure can be provided to make them more processable, for example, to inhibit dusting of the fine particles or make them more fluid, or provided to improve properties, for example, to modify dispersion of the fine particles in the plasticizer. Thus, the structure can be designed as appropriate depending on applications and demands.

In the acrylic polymer comprising primary particles having a core-shell structure used in the present invention, the core polymer and the shell polymer can be graft bonded by a graft crossing agent. As the graft crossing agent in this case, allyl methacrylate and the like can be utilized.

The core polymer and/or the shell polymer may also be cross-linked. As cross-linkable monomers used in this case, polyfunctional monomers can be utilized. Moreover, besides polyfunctional monomers, a divalent or higher-valent alkali metal, a polyfunctional amine or the like can be added to effect ionic cross-linking with a carboxyl group or a sulfonic acid group.

The resin composition for a molding material according to the present invention can be blended with various additives or materials depending on the application. For example, there may be freely added fillers such as calcium carbonate, aluminum hydroxide, baryta, clay, colloidal silica, mica powder, siliceous sand, diatomaceous earth, kaolin, talc, bentonite, glass powder and aluminum oxide, pigments such as titanium oxide and carbon black, diluents such as mineral turpentine and mineral spirit, antifoaming agents, antifungal agents, deodorants, antibacterial agents, surface active agents, stabilizers, processing aids (e.g. Metablen P, manufactured by Mitsubishi Rayon Co., Ltd.), lubricants (e.g. Metablen L, manufactured by Mitsubishi Rayon Co., Ltd.), impact modifiers (e.g. Metablen C, manufactured by Mitsubishi Rayon Co., Ltd.), ultraviolet absorbers, antioxidants, delustering agents, modifiers, perfumes, foaming agents, leveling agents, adhesives and the like.

If a filler is added into the resin composition according to the present invention, it may be preferably added between 0 and 400 parts by weight per 100 parts by weight of the polymer. If the blended amount is not more than 400 parts by weight, the molded article tends to be stronger. The lower limit of this content is preferably 10 parts by weight, and more preferably 30 parts by weight. The upper limit of this content is preferably 200 parts by weight, and more preferably 100 parts by weight.

In the present invention, the blending method of the acrylic polymer and the plasticizer is not particularly limited, although when simply blending it can be broadly classified into three types: (1) that which forms a powder; (2) that which forms a gel agglomeration; and (3) that which forms a sol.

Although type (1) can be carried out using conventional vinyl chloride processing equipment as an alternative material for flexible vinyl chloride resin, types (2) and (3) cannot always be carried out using conventional processing equipment. This problem can be overcome by heating the resin composition in advance, and then forming the melted resin into pellets.

In the present invention, the blending ratio of the plasticizer to the acrylic polymer is usually from 140 parts by weight to 5 parts by weight per 100 parts by weight of acrylic polymer, and preferably from 100 parts by weight to 10 parts by weight, although this does depend on the type of plasticizer. If the blending ratio of the plasticizer exceeds 140 parts by weight, the viscosity becomes too low, and if less than 5 parts by weight, moldability deteriorates.

The resin composition for a molding material according to the present invention can be molded by various conventionally-known molding processes, such as T-die extrusion, profile extrusion, solvent casting, inflation technique, calendering, injection molding, blow molding, vacuum forming and the like.

In a calendering process, for example, the equipment employed includes an extruder as used in the production of vinyl chloride resin film, a mixer such as a Banbury mixer, a film-forming apparatus which comprises a plurality of metal rolls, and a winder which winds the obtained film. In this process, the mixing state of the composition in the mixer, bank control in the roll film-forming apparatus, and the detachability of the film from the roll surface are important in determining how good moldability is.

In addition to being used as-is, a film or sheet obtained by molding the resin composition for a molding material according to the present invention can be used as a substrate surface layer, or as an intermediate layer in cases where there are three or more substrate surface layers.

A substrate which consists of a variety of thermoplastic resins can be used as the above-described substrate. Specifically, acrylic resins, polycarbonate resins, vinyl chloride resins, ABS resins and the like can be used. Further, it is possible to stick to even substrates such as resins which do not thermally fuse with the resin composition for a molding material according to the present invention, or wood, steel sheeting or the like, by using an adhesive.

The production process for a laminated material is not particularly limited. Although various laminating processes can be employed, a heat lamination process using a heating roller is preferable.

### EXAMPLES

The present invention will now be described in more detail by referring to examples, although the present invention is not limited in any way by these examples. In the below examples, the term “parts” is always defined in terms of weight.

### [Production of Polymer Particles A1]

Used as the monomer mixture Mc for core polymer molding was a uniform mixture of 420.8 g of methyl methacrylate and 398.2 g of n-butyl methacrylate.

Used as the monomer mixture Ms for shell polymer molding was a uniform mixture of 533.1 g of methyl methacrylate, 199.1 g of i-butyl methacrylate and 24.08 g of methacrylic acid.

A 5-liter, 4-necked flask equipped with a thermometer, a nitrogen gas introducing pipe, a stirrer, a dropping funnel and a condenser tube, was charged with 1,414 g of pure water, followed by sufficiently passing nitrogen gas therethrough for 30 minutes to replace the dissolved oxygen in the pure water. After the passing of nitrogen gas was stopped, 1/10 of the monomer mixture Mc for core polymer molding was charged therein. The temperature was then raised to 80° C. while stirring at 150 rpm. When the internal temperature reached 80° C., 0.70 g of potassium persulfate dissolved in 28 g of pure water was added at once and soap-free polymerization was started. In this state, the stirring was continued for 60 minutes at 80° C. to obtain a seed particle dispersion.

Subsequently, a monomer emulsion (prepared by mixing 9/10 of the monomer mixture Mc for core polymer molding with 7.00 g of sodium dialkylsulfosuccinate (trade name: Pelex O-TP manufactured by Kao Co., Ltd.; hereinafter the same) and 350.0 g of pure water with stirring to perform emulsification) was added dropwise to the above seed particle dispersion over 2.5 hours, followed by continuing stirring for 1 hour at 80° C. to obtain a polymer dispersion.

Next, a monomer emulsion (prepared by mixing all of the monomer mixture Ms for shell polymer molding with 7.00 g of sodium dialkylsulfosuccinate and 350.0 g of pure water with stirring to perform emulsification) was added dropwise to the above polymer dispersion over 2.5 hours, followed by continuing stirring for 1 hour at 80° C. to obtain a polymer dispersion.

The resulting polymer dispersion was cooled to room temperature and then spray dried using a spray dryer (Model L-8 manufactured by Ohkawara Kakohki Co., Ltd.) with an inlet temperature of 170° C., an outlet temperature of 75° C., and a revolving number of the atomizer at 25,000 rpm to obtain the polymer particles A1.

The weight average molecular weight of the obtained polymer particles A1 and the particle size of the primary particles are shown in Table 1.

### [Production of Polymer Particles A2]

Used as the monomer mixture Mc for core polymer molding was a uniform mixture of 245.6 g of methyl methacrylate and 348.5 g of n-butyl methacrylate.

Used as the monomer mixture Ms for shell polymer molding was a uniform mixture of 693.0 g of methyl methacrylate, 258.9 g of n-butyl methacrylate and 31.36 g of methacrylic acid.

After this, a seed particle dispersion was obtained by carrying out soap-free polymerization in the same manner as in the production example of polymer particles A1. Subsequently, a monomer emulsion (prepared by mixing the remaining 9/10 of the monomer mixture Mc for core polymer molding with 4.90 g of sodium dialkylsulfosuccinate and 245.0 g of pure water with stirring to perform emulsification) was added dropwise to the above seed particle dispersion over 1.75 hours, followed by continuing stirring for 1 hour at 80° C. to obtain a polymer dispersion.

Next, a monomer emulsion (prepared by mixing all of the monomer mixture Ms for shell polymer molding with 9.10 g of sodium dialkylsulfosuccinate and 455.0 g of pure water with stirring to perform emulsification) was added dropwise to the above polymer dispersion over 3.25 hours, followed by continuing stirring for 1 hour at 80° C. to obtain a polymer dispersion.

Polymer particles A2 were then obtained in the same manner as in the production example of polymer particles A1.

The weight average molecular weight of the obtained polymer particles A2 and the particle size of the primary particles are shown in Table 1.

### [Production of Polymer Particles A3]

Used as the monomer mixture Mc for core polymer molding was a uniform mixture of 456.0 g of methyl methacrylate and 348.5 g of n-butyl methacrylate.

Used as the monomer mixture Ms for shell polymer molding was a uniform mixture of 470.0 g of methyl methacrylate, 288.7 g of n-butyl methacrylate, 12.04 g of methacrylic acid and 18.20 g of 2-hydroxyethyl methacrylate.

After this, a seed particle dispersion was obtained by carrying out soap-free polymerization in the same manner as in the production example of polymer particles A1. Subsequently, a polymer dispersion was obtained by subjecting this seed particle dispersion to the same treatment as in the production example of polymer particles A1.

Next, a monomer emulsion (prepared by mixing all of the monomer mixture Ms for shell polymer molding with 7.00 g of sodium dialkylsulfosuccinate and 350.0 g of pure water with stirring to perform emulsification) was added dropwise to the above polymer dispersion over 2.5 hours, followed by continuing stirring for 1 hour at 80° C. to obtain a polymer dispersion.

Polymer particles A3 were then obtained in the same manner as in the production example of polymer particles A1.

The weight average molecular weight of the obtained polymer particles A3 and the particle size of the primary particles are shown in Table 1.

### [Production of Polymer Particles A4]

Used as the monomer mixture Mc for core polymer molding was a uniform mixture of 589.1 g of methyl methacrylate and 557.5 g of n-butyl methacrylate.

Used as the monomer mixture Ms for shell polymer molding was a uniform mixture of 319.9 g of methyl methacrylate, 119.4 g of n-butyl methacrylate and 14.42 g of methacrylic acid.

After this, a seed particle dispersion was obtained by carrying out soap-free polymerization in the same manner as in the production example of polymer particles A1, except that 910 g of pure water was charged into the flask.

Subsequently, a monomer emulsion (prepared by mixing the remaining 9/10 of the monomer mixture Mc for core polymer molding with 9.80 g of sodium dialkyl-sulfosuccinate and 490.0 g of pure water with stirring to perform emulsification) was added dropwise to the above seed particle dispersion over 3.5 hours, followed by continuing stirring for 1 hour at 80° C. to obtain a polymer dispersion.

Next, a monomer emulsion (prepared by mixing all of the monomer mixture Ms for shell polymer molding with 4.20 g of sodium dialkylsulfosuccinate and 210.0 g of pure water with stirring to perform emulsification) was added dropwise to the above polymer dispersion over 1.5 hours, followed by continuing stirring for 1 hour at 80° C. to obtain a polymer dispersion.

Polymer particles A4 were then obtained in the same manner as in the production example of polymer particles A1.

The weight average molecular weight of the obtained polymer particles A4 and the particle size of the primary particles are shown in Table 1.

### [Production of Polymer Particles A5]

Used as the monomer mixture Mc for core polymer molding was a uniform mixture of 280.6 g of methyl methacrylate and 597.2 g of n-butyl methacrylate.

Used as the monomer mixture Ms for shell polymer molding was a uniform mixture of 533.1 g of methyl methacrylate, 199.1 g of n-butyl methacrylate and 24.08 g of methacrylic acid.

After this, a seed particle dispersion was obtained by carrying out soap-free polymerization in the same manner as in the production example of polymer particles A4.

Subsequently, a monomer emulsion (prepared by mixing the remaining 9/10 of the monomer mixture Mc for core polymer molding with 7.00 g of sodium dialkyl-sulfosuccinate and 350.0 g of pure water with stirring to perform emulsification) was added dropwise to the above seed particle dispersion over 2.5 hours, followed by continuing stirring for 1 hour at 80° C. to obtain a polymer dispersion.

Next, a monomer emulsion (prepared by mixing all of the monomer mixture Ms for shell polymer molding with 7.00 g of sodium dialkylsulfosuccinate and 350.0 g of pure water with stirring to perform emulsification) was added dropwise to the above polymer dispersion over 2.5 hours, followed by continuing stirring for 2.5 hours at 80° C. to obtain a polymer dispersion.

Polymer particles A5 were then obtained in the same manner as in the production example of polymer particles A1.

The weight average molecular weight of the obtained polymer particles A5 and the particle size of the primary particles are shown in Table 1.

### [Production of Polymer Particles A6]

Used as the monomer mixture Mc for core polymer molding was a uniform mixture of 592.6 g of methyl methacrylate and 452.9 g of n-butyl methacrylate.

Used as the monomer mixture Ms for shell polymer molding was a uniform mixture of 392.8 g of methyl methacrylate, 111.4 g of n-butyl methacrylate and 27.86 g of glycidyl methacrylate.

After this, a seed particle dispersion was obtained by carrying out soap-free polymerization in the same manner as in the production example of polymer particles A1. Subsequently, a monomer emulsion (prepared by mixing the remaining 9/10 of the monomer mixture Mc for core polymer molding with 9.10 g of sodium dialkylsulfosuccinate and 455.0 g of pure water with stirring to perform emulsification) was added dropwise to the above seed particle dispersion over 3.25 hours, followed by continuing stirring for 1 hour at 80° C. to obtain a polymer dispersion.

Next, a monomer emulsion (prepared by mixing all of the monomer mixture Ms for shell polymer molding with 4.90 g of sodium dialkylsulfosuccinate and 245.0 g of pure water with stirring to perform emulsification) was added dropwise to the above polymer dispersion over 1.75 hours, followed by continuing stirring for 1 hour at 80° C. to obtain a polymer dispersion.

Polymer particles A6 were then obtained in the same manner as in the production example of polymer particles A1.

The weight average molecular weight of the obtained polymer particles A6 and the particle size of the primary particles are shown in Table 1.

### [Production of Polymer Particles A7]

Used as the monomer mixture Mc for core polymer molding was a uniform mixture of 420.8 g of methyl methacrylate and 398.2 g of n-butyl methacrylate.

Used as the monomer mixture Ms for shell polymer molding was a uniform mixture of 673.4 g of methyl methacrylate and 39.76 g of methacrylic acid.

After this, polymer particles A7 were then obtained in the same manner as in the production example of polymer particles A1.

The weight average molecular weight of the obtained polymer particles A7 and the particle size of the primary particles are shown in Table 1.

### [Production of Polymer Particles A8]

Used as the monomer mixture Mc for core polymer molding was a uniform mixture of 561.1 g of methyl methacrylate and 258.0 g of 2-ethylhexyl acrylate.

Used as the monomer mixture Ms for shell polymer molding was a uniform mixture of 631.3 g of methyl methacrylate, 74.62 g of 2-ethylhexyl acrylate and 24.08 g of methacrylic acid.

After this, polymer particles A8 were then obtained in the same manner as in the production example of polymer particles A1.

The weight average molecular weight of the obtained polymer particles A8 and the particle size of the primary particles are shown in Table 1.

### [Production of Polymer Particles B1]

Used as the monomer mixture Mc for core polymer molding was a uniform mixture of 561.1 g of methyl methacrylate and 199.1 g of n-butyl methacrylate.

Used as the monomer mixture Ms for shell polymer molding was a uniform mixture of 420.8 g of methyl methacrylate, 358.4 g of n-butyl methacrylate and 24.08 g of methacrylic acid.

After this, polymer particles B1 were then obtained in the same manner as in the production example of polymer particles A1.

The weight average molecular weight of the obtained polymer particles B1 and the particle size of the primary particles are shown in Table 1.

### [Production of Polymer Particles B2]

Used as the monomer mixture Mc for core polymer molding was a uniform mixture of 392.8 g of methyl methacrylate and 139.3 g of n-butyl methacrylate. Used as the monomer mixture Ms for shell polymer molding was a uniform mixture of 547.1 g of methyl methacrylate, 465.8 g of n-butyl methacrylate and 31.36 g of methacrylic acid.

After this, a seed particle dispersion was obtained by carrying out soap-free polymerization in the same manner as in the production example of polymer particles A1. Subsequently, a monomer emulsion (prepared by mixing the remaining 9/10 of the monomer mixture Mc for core polymer molding with 4.90 g of sodium dialkylsulfosuccinate and 245.0 g of pure water with stirring to perform emulsification) was added dropwise to the above seed particle dispersion over 1.75 hours, followed by continuing stirring for 1 hour at 80° C. to obtain a polymer dispersion.

Next, a monomer emulsion (prepared by mixing all of the monomer mixture Ms for shell polymer molding with 9.10 g of sodium dialkylsulfosuccinate and 455.0 g of pure water with stirring to perform emulsification) was added dropwise to the above polymer dispersion over 3.25 hours, followed by continuing stirring for 1 hour at 80° C. to obtain a polymer dispersion.

Polymer particles B2 were then obtained in the same manner as in the production example of polymer particles A1.

The weight average molecular weight of the obtained polymer particles B2 and the particle size of the primary particles are shown in Table 1.

TABLE 1

| | | | | Weight | |
|---|---|---|---|---|---|
| | | | Core/Shell | Average | Particle |
| Polymer | Monomer Composition (mol %) | | Ratio | Molecular | Size |
| Particles | Core (Mc) | Shell (Ms) | (mol ratio) | Weight | (nm) |
| A1 | MMA/nBMA | MMA/nBMA/MAA | 50/50 | 700,000 | 350 |
| | 60/40 | 76/20/4 | | | |
| A2 | MMA/nBMA | MMA/nBMA/MAA | 35/65 | 800,000 | 340 |
| | 50/50 | 76/20/4 | | | |
| A3 | MMA/nBMA | MMA/iBMA/MAA/2HEMA | 50/50 | 900,000 | 400 |
| | 65/35 | 69/29/2/2 | | | |
| A4 | MMA/nBMA | MMA/nBMA/MAA | 70/30 | 1,000,000 | 1460 |
| | 60/40 | 76/20/4 | | | |
| A5 | MMA/nBMA | MMA/nBMA/MAA | 50/50 | 800,000 | 1410 |
| | 40/60 | 76/20/4 | | | |
| A6 | MMA/nBMA | MMA/nBMA/GMA | 65/35 | 600,000 | 450 |
| | 65/35 | 80/16/4 | | | |
| A7 | MMA/nBMA | MMA/MAA | 50/50 | 800,000 | 380 |
| | 60/40 | 96/4 | | | |
| A8 | MMA/2EHA | MMA/2EHA/MAA | 50/50 | 1,800,000 | 300 |
| | 80/20 | 90/6/4 | | | |
| B1 | MMA/nBMA | MMA/nBMA/MAA | 50/50 | 1,000,000 | 350 |
| | 80/20 | 60/36/4 | | | |
| B2 | MMA/nBMA | MMA/nBMA/MAA | 35/65 | 700,000 | 340 |
| | 80/20 | 60/36/4 | | | |

### Examples 1 to 22 and Comparative Examples 1 to 5

Weighed out in the ratios shown in Table 2 were: the acrylic polymers A1 to A8 and B1 and B2 obtained in the above-described production examples; dioctyl phthalate (DOP); diisononyl phthalate (DINP); a polyether ester; a polyester plasticizer such as polyester adipate; a butyl acrylate polymer having a molecular weight of from 1,000 to 10,000; an acrylic oligomer such as a butyl acrylate-styrene co-polymer; and polypropylene glycol. The resulting mixtures were stirred with a Banbury mixer to obtain a compound.

### Examples 23 to 27

Weighed out in the ratios shown in Table 3 were: the acrylic polymer A1 obtained in the above-described production example; diisononyl phthalate; calcium carbonate; an antioxidant and a lubricant. The resulting mixtures were stirred with a Banbury mixer to obtain a compound.

For Examples 1 to 27 and Comparative Examples 1 to 5, the compounds blended in accordance with the compound formulae of Table 2 were pelletized using a co-rotating twin screw extruder (4-channel die) with set temperatures for C1, C2, C3, C4, C5, C6, C7 and D of, in order, 110° C., 150° C., 170° C., 180° C., 190° C., 190° C., 200° C. and 200° C., a motor revolution of 230 rpm and a feeder revolution of 15 rpm. The pellets were kneaded with an 8-inch test roll at a set temperature of 160° C. to form a sheet. Processability during roll molding and various physical properties of the obtained sheets were evaluated. These results are shown in Table 2.

For Examples 23 to 27, the compounds blended in accordance with the compound formulae of Table 3 were pelletized in the same manner using a counter-rotating twin screw extruder. The pellets were formed into dumbbell test pieces using an injection molding machine. The injection molding conditions were: a 50 t injection molding machine made by Kawaguchi Co., Ltd.; set temperatures for C1, C2, C3, C4 and N of, in order, 150° C., 170° C., 200° C., 200° C. and 200° C. The metal die was a dumbbell test piece (marked), the metal die temperature was 25° C., the injection rate was 90% (single speed), the injection pressure was 29.4% (SS+3%), the gauge was 55 mm, the revolution speed was 24%, injection was for 15 seconds, cooling was for 30 seconds, and the back pressure was 2%. Tensile strength was measured from the obtained dumbbell test pieces. These results are shown in Table 3.

The respective evaluations described in Tables 2 and 3 were carried out in the below manner.

### (1) Bank Control

When the rolls were rotating with a uniform bank, it was rated as “◯”, and otherwise it was rated as “x”

### (2) Hardness

In accordance with JIS K7202, six 1 mm thick roll sheets were stacked on top of each other and subjected to press molding. The hardness of the obtained sheets was measured using a hardness meter.

### (3) Tear Strength

In accordance with JIS K6252, 1 mm thick roll sheets were cut out, and then punched with an angled metal die, to thereby form test pieces with a testing machine. Tear strength was measured at a tensile speed of 200 mm/min and a distance between the chucks of 60 mm using an Instron tensile tester (units: N/mm²).

### (4) Plasticizer Bleeding

Two sheets obtained from roll molding were sandwiched by glass plates. A static load of 10 kg/100 cm² was placed for 120 minutes at 100° C. with the gear open. The surface condition of the sheets was then visually observed.

◯: No bleeding

x: Bleeding Occurred

### (5) Tensile Strength and Tensile Elongation

An ASTM No. 1 dumbbell test piece obtained by injection molding was subjected to a tension test in accordance with the method described in ASTM D638 at a tensile speed of 50 mm/min and a chuck interval of 115 mm using an Instron tensile tester, whereby the tensile strength at break and tensile elongation at break were obtained (tensile strength units: MPa; tensile elongation units: %).

TABLE 2

| | | | | Processability and | | | |
|---|---|---|---|---|---|---|---|
| | | | | Physical Properties | | | |
| | Compound (parts by weight) | | | Bank | | Tear | |
| | Polymer | Plasticizer | Additive | Control | Hardness | Strength | Bleeding |
| Ex. 1 | A1 | DOP | | ◯ | 10 | 10 | ◯ |
| | (100) | (100) | | | | | |
| Ex. 2 | A2 | DINP | | ◯ | 10 | 10 | ◯ |
| | (100) | (100) | | | | | |
| Ex. 3 | A3 | DINP | | ◯ | 10 | 10 | ◯ |
| | (100) | (100) | | | | | |
| Ex. 4 | A3 | Polyester type | | ◯ | 30 | 30 | ◯ |
| | (100) | (50) | | | | | |
| Ex. 5 | A3 | Acrylic oligomer | | ◯ | 30 | 30 | ◯ |
| | (100) | (50) | | | | | |
| Ex. 6 | A3 | DINP | Metablen C | ◯ | 30 | 30 | ◯ |
| | (100) | (50) | (10) | | | | |
| Ex. 7 | A3 | Polyester type | Metablen W | ◯ | 30 | 25 | ◯ |
| | (100) | (50) | (30) | | | | |
| Ex. 8 | A3 | Polyester type | Metablen S | ◯ | 30 | 30 | ◯ |
| | (100) | (50) | (10) | | | | |
| Ex. 9 | A3 | DINP | Metablen P | ◯ | 30 | 30 | ◯ |
| | (100) | (50) | (5) | | | | |
| Ex. 10 | A3 | DINP | Metablen L | ◯ | 30 | 30 | ◯ |
| | (100) | (50) | (3) | | | | |
| Ex. 11 | A4 | DINP | | ◯ | 10 | 10 | ◯ |
| | (100) | (100) | | | | | |
| Ex. 12 | A5 | DINP | | ◯ | 10 | 10 | ◯ |
| | (100) | (100) | | | | | |
| Ex. 13 | A1 | DINP | | ◯ | 10 | 10 | ◯ |
| | (100) | (100) | | | | | |
| Ex. 14 | A6 | DINP | | ◯ | 10 | 10 | ◯ |
| | (100) | (100) | | | | | |
| Ex. 15 | A6 | Polyester type | | ◯ | 30 | 30 | ◯ |
| | (100) | (50) | | | | | |
| Ex. 16 | A6 | PPG | Modifier | ◯ | 30 | 30 | ◯ |
| | (100) | (50) | (3) | | | | |
| Ex. 17 | A7 | DINP | | ◯ | 10 | 10 | ◯ |
| | (100) | (100) | | | | | |
| Ex. 18 | A8 | DINP | | ◯ | 10 | 10 | ◯ |
| | (100) | (100) | | | | | |
| Ex. 19 | A5 | DINP | | ◯ | 20 | 20 | ◯ |
| | (100) | (75) | | | | | |
| Ex. 20 | A5 | DINP | | ◯ | 30 | 30 | ◯ |
| | (100) | (50) | | | | | |
| Ex. 21 | A5 | DINP | | ◯ | 40 | 40 | ◯ |
| | (100) | (25) | | | | | |
| Ex. 22 | A3/A6 | DINP | | ◯ | 30 | 30 | ◯ |
| | (50/50) | (50) | | | | | |
| Comp. | B1 | DOP | | X | *1 | *1 | X |
| Ex. 1 | (100) | (100) | | | | | |
| Comp. | B1 | DINP | | X | *1 | *1 | X |
| Ex. 2 | (100) | (100) | | | | | |
| Comp. | B1 | DINP | | X | *1 | *1 | X |
| Ex. 3 | (100) | (75) | | | | | |
| Comp. | B1 | DINP | | X | 30 | 10 | X |
| Ex. 4 | (100) | (50) | | | | | |
| Comp. | B1 | DINP | | X | 40 | 20 | X |
| Ex. 5 | (100) | (25) | | | | | |

*1: Molding of the sheet by rolling was impossible (severe bleeding)

TABLE 3

| | | | | Processability and | | |
|---|---|---|---|---|---|---|
| | Compound | | | Physical Properties | | |
| | (parts by weight) | | | Tensile | Tensile | |
| | Polymer | Plasticizer | Filler | Strength | Elongation | Hardness |
| Ex. | A6 | Polyester | Whiton | 6.8 | 156 | 88 |
| 23 | (100) | type (40) | SB (70) | | | |
| Ex. | A1 | Polyester | Whiton | 6.7 | 138 | 97 |
| 24 | (100) | type (40) | SB (70) | | | |

The abbreviations used in Tables 2 and 3 are as follows.
DOP: Dioctyl phthalate
DINP: Diisononyl phthalate
Polyester type: (W2310, manufactured by Dainippon Ink and Chemicals Incorporated)
PPG: Polypropylene glycol (Adeka Polyether P-700, manufactured by Asahi Denka Co., Ltd.)
Acrylic oligomer: ARUFON UP1021 (manufactured by Toagosei Co., Ltd.)
Modifier: Maleic acid anhydride
Metablen C: C201A (impact modifier, manufactured by Mitsubishi Rayon Co., Ltd.)
Metablen W: W341 (weatherable impact modifier, manufactured by Mitsubishi Rayon Co., Ltd.)
Metablen S: S2001 (weatherable impact modifier, manufactured by Mitsubishi Rayon Co., Ltd.)
Metablen L: 1000 (acrylic polymer lubricant, manufactured by Mitsubishi Rayon Co., Ltd.)
Metablen P: 530A (acrylic processing aid, manufactured by Mitsubishi Rayon Co., Ltd.)
Whiton SB: Heavy calcium carbonate (manufactured by Shiraishi Kogyo Kaisha Ltd.)

### INDUSTRIAL APPLICABILITY

The resin composition for a molding material according to the present invention can be widely employed in the production of packing, gaskets, interior articles such as wallpaper, toys, daily necessities, and miscellaneous goods, films, sheets, profile extrusion molded articles, injection molded articles and the like, in which vinyl chloride resins have been conventionally used

1. A method, comprising:
extrusion molding, roll molding, or injection molding a resin composition:
wherein:
the resin composition comprises 100 parts by weight of an acrylic polymer having a weight average molecular weight of between 200,000 and 5,000,000;
the resin composition comprises 10 to 100 parts by weight of a plasticizer per 100 parts by weight of the acrylic polymer;
the acrylic polymer consists of primary particles which have a core-shell structure comprising a core polymer and a shell polymer;
the core polymer and shell polymer comprise methyl methacrylate monomer units; and
the core polymer has a lower content of methyl methacrylate monomer units than the shell polymer.

2. The method according to claim 1, wherein the primary particles have an average particle size of 250 nm or more.

3. A molded article produced by the method according to claim 1 or claim 2.
